(19) United States
(12) Patent Application Publication
(10) Pub. No.: US 2013/0024148 A1
(43) Pub. Date: Jan. 24, 2013

(54) Electromagnetic Wave Source Survey Method, Electromagnetic Wave Source Survey Program, and Electromagnetic Wave Source Survey Device

(71) Applicants: Satoshi Nakamura, Yokohama (JP); Hitoshi Yokota, Kawasaki (JP)

(72) Inventors: Satoshi Nakamura, Yokohama (JP); Hitoshi Yokota, Kawasaki (JP)

(73) Assignee: Hitachi, Ltd., Chiyoda-ku, Tokyo (JP)

(21) Appl. No.: 13/575,189

(22) PCT Filed: Jan. 25, 2011
(86) PCT No.: PCT/JP2011/051322

§ 371 Date: Oct. 2, 2012

(30) Foreign Application Priority Data
Jan. 26, 2010 (JP) 2010-014412

(51) Int. Cl. G06F 19/00

(52) U.S. Cl. 702/66

(57) ABSTRACT

There is provided a technique in which a direction of current to be an electromagnetic wave source is precisely measured in a short time. An electromagnetic wave source survey method according to the present invention measures an absolute value of induced voltages by using three or more odd number of antennas whose arrangement angles seen from the reference position on a same plane are different from one another, and a vectorial angle of the current is calculated by using the arrangement angle of each antenna and the induced voltages (see FIG. 3).

### TECHNICAL FIELD

The present invention relates to a technique for surveying an electromagnetic wave source generating electromagnetic waves.

### BACKGROUND ART

Along with increasingly lower voltages for semiconductors mounted on electric/electronic devices in recent years, acceleration in speed thereof and popularization of radio communication devices, problems of electromagnetic wave environment (EMC) are becoming more serious. EMC is the cause of deterioration in the immunity level of a device, increase in the electromagnetic radiation level, and interference in the interior of the device. EMC problems become more complex along with the increasingly lower voltage and acceleration in speed of semiconductors. In order to avoid an extension of the period for developing a product required for addressing the EMC problems and for providing countermeasures, it is a key to construct an optimal design technique based on EMC mechanisms.

In order to work out the EMC mechanisms, it is important to specify a wave source of the electromagnetic radiation and propagation path of noise. Therefore, there are some cases where it is needed to measure a current flowing on the surface of a metal casing and on the surface of a substrate of the device. In order to identify a wave source and a propagation path, it is important to measure the direction and the angle in and at which the current is flowing with a high precision and in a short time. Such a measurement makes it possible to efficiently work out the EMC mechanism.

Patent Literature 1 below describes a magnetic field detection device and a magnetic field distribution measuring device that can measure magnetic field components (equivalent to current components) in different directions with high resolution by using three magnetic probes set to be orthogonal to one another with respect to XYZ planes.

Patent Literature 2 below describes an electromagnetic field intensity detection device that detects electromagnetic field intensity of a predefined level or greater in a simplified manner by using three non-directional antennas.

Patent Literature 3 below describes an EMI (Electromagnetic Interference) measuring device and a method of measurement in which a loop-antenna for magnetic field measurement is mounted to four-axis scanner that operates in XYZ directions and θ direction (a direction of rotation about the Z axis) to scan an EUT (equipment under test). The device and method enable measuring an intensity distribution,a phase and a direction of current.

### CITATION LIST

### Patent Literature

Patent Literature 1: Japanese Patent Application No. H10-111350 (1998)
Patent Literature 2: Japanese Patent Application No. 2007-325916
Patent Literature 3: Japanese Patent Application No. H11-156317 (1999)

### SUMMARY OF INVENTION

### Technical Problem

Above-mentioned Patent Literature 1 proposes a technique that measures magnetic field (current) distribution by using three magnetic probes set to be orthogonal to one another in XYZ planes. However, in the case where the direction of current is estimated by using these probes, it is difficult, for example, to discriminate currents flowing respectively in the directions of 45 and 135 degrees with the X plane being reference. This is due to the fact that the voltages induced at the probes by the magnetic field generated by the respective currents flowing in the directions of 45 and 135 degrees on the XY plane are completely the same as one another in both X and Y directions. Therefore, it becomes difficult to discriminate in which directions of 45 and 135 degrees the induced voltages of the magnetic probe face on the XY plane. In the case where the three magnetic probes each corresponding to XYZ axis are used, other than the angles of 45 and 135 degrees, there are some directions between which it is difficult to discriminate the directions from one another, such as, directions of 30 and 150 degrees. Therefore, it is difficult to estimate the direction of current.

Above-mentioned Patent Literature 2 proposes an electromagnetic field measuring device using three antennas. However, since all of the three antennas are non-directional, it is difficult to estimate the direction of current that is the wave source.

Above-mentioned Patent Literature 3 proposes a measuring device having a loop-antenna for magnetic field measurement mounted on a four-axis scanner operating in XYZ directions and θ direction. The device rotates a probe for a magnetic field measurement in θ direction directly above the current, and scans on the XY plane. The angle at which induced voltage on the probe becomes the maximum is the direction of current in the XY plane. Therefore, by measuring the magnetic field (current) map by rotating the probe for magnetic field measurement in the θ direction while scanning on the XY plane, to map the angle at which the induced voltage on the probe has become the maximum at each scanning point, it is possible to estimate the direction of current flowing on the XY plane.

However, it is necessary to set fine probe rotation angles in order to improve precision in estimation of the direction of current in the device. For example, in order to measure with a precision of ±10 degrees, measurement must be performed at 18 points, that is, one point for each 10 degrees in the probe rotation range of 0-180 degrees. Actually, a value obtained by multiplying the number of the points of measurement on the XY plane by the number of points of the rotation angle is the number of the points of measurement. Therefore, improvement in the precision in estimation of the direction will result in the increased number of points of measurement, leading to an extended measuring time. In other words, the precision in estimation and the measuring time are in the relationship of trade-off.

For example, in the case of measuring 30 points in X direction, 20 points in Y direction and 2 points in the direction of rotation (0 degree and 90 degrees), the number of points of measurement is 30×20×2=1200 points, which results in the measuring time of around an hour. In the case of measuring 9 times more number of steps, that is, 18 points in the direction of rotation, the number of points of measurement is nearly ten times more, with the increase in measuring time according to the increased number of points. Therefore, it is required to precisely estimate a direction of current in a short time.

The present invention is made to overcome the above-mentioned problems, and an object of the present invention is to provide a technique to precisely measure the direction of current that is to be the electromagnetic wave source in a short time.

### Solution to Problem

In an electromagnetic wave source survey method according to the present invention, absolute values of induced voltages are measured by using three or more odd number of antennas whose respective arrangement angles seen from a reference position on the same plane are different from one another, and a vectorial angle of current is calculated by using arrangement angles of each antenna and induced voltages.

### Advantageous Effects of Invention

According to the electromagnetic wave source survey method of the present invention, since only the absolute values of the induced voltages are used, it is possible to perform measurement in a short time. Further, since the present invention uses three or more odd number of antennas on the same plane, it is possible to ensure that the direction of current in arbitrary directions can be discriminated to yield a good precision in estimation.

### BRIEF DESCRIPTION OF DRAWINGS

FIG. 1 is a schematic diagram of an electromagnetic wave source survey device 100 according to embodiment 1.

FIG. 2 is a diagram showing generation of an induced voltage on an antenna 111 by a current flowing on EUT 200.

FIG. 3 is a diagram for explaining a method for estimating a direction of the voltage and current induced on the antenna module 110.

FIG. 4 is an operation flow of an electromagnetic wave source survey device 100.

FIG. 5 is a schematic diagram of an electromagnetic wave source survey device 100 according to embodiment 2.

FIG. 6 is a schematic diagram of an electromagnetic wave source survey device 100 according to embodiment 3.

FIG. 7 is a schematic diagram according to an electromagnetic wave source survey device 100 of embodiment 4.

FIG. 8 is a diagram for explaining a method for estimating a direction of a voltage and a current induced on the antenna module 110.

FIG. 9 shows a side cross-sectional view of the antenna module 110.

FIG. 10 is a plan view showing the faces 1100-1300 seen from the side of the coaxial cable 2000.

FIG. 10 is a perspective view of an antenna array substrate 3000 according to embodiment 8.

### DESCRIPTION OF EMBODIMENTS

### Embodiment 1

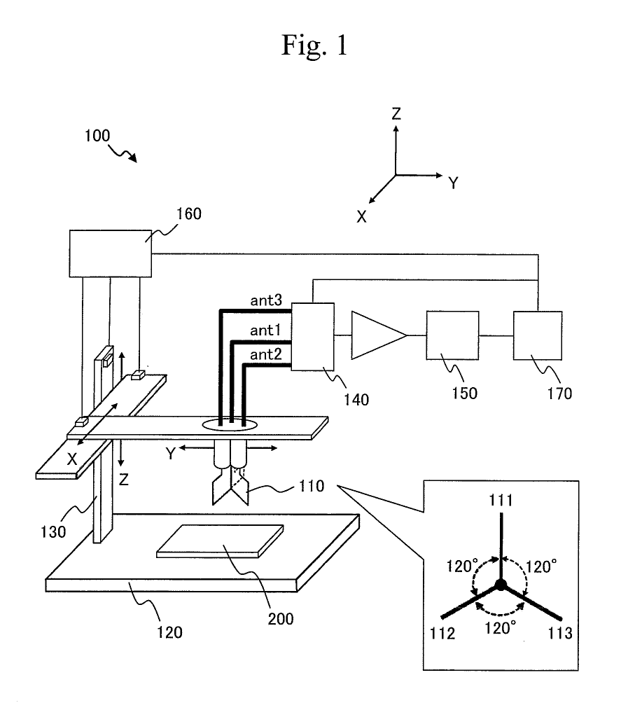

FIG. 1 is a schematic diagram of an electromagnetic wave source survey device 100 according to embodiment 1 of the present invention. The electromagnetic wave source survey device 100 is a device that measures the direction of current that is to be the electromagnetic waves generation source by flowing on the EUT 200. The electromagnetic wave source survey device 100 comprises an antenna module 110, a stage 120, a three-axis scanner 130, a coaxial switch 140, a spectrum analyzer 150, a motor control unit 160 and a control computer 170.

The EUT 200 is fixed to the stage 120.

The antenna module 110 comprises three antennas 111, 112 and 113. An induced voltage is generated on each antenna by the electromagnetic wave source. Each antenna detects the induced voltage and outputs the output signal corresponding to the value thereof

A coaxial switch 140 receives each output of the antenna module 110, amplifies the output signal via an amplifier as necessary, to outputs to the spectrum analyzer 150.

The control computer 170 controls the three-axis scanner 130 via the motor control unit 160 to thereby move the antenna module 110 in each of XYZ directions. Further, the control computer 170 controls which one of outputs of the antenna module 110 to receive by switching the coaxial switch 140. Other than this, by acquiring a measurement result for each frequency of the antenna module 110 from the spectrum analyzer 150, the control computer 170 calculates the direction of current on the EUT 200 based on the measurement result. The details of method for the calculation will be described later. The control computer 170 corresponds to an “arithmetic device” in embodiment 1.

The diagram in the lower right of FIG. 1 shows an arrangement of each antenna of the antenna module 110 as seen from the bottom face (the side of the EUT 200 in FIG. 1). The three antennas 111, 112, 113 provided for the antenna module 110 are arranged so that, when, for example, the direction in which the antenna 111 faces is a reference angle, the arrangement angles seen from the reference angle on a same plane are different from one another by 120 degrees. In other words, the each antenna is arranged radially at angles of 120 degrees incrementing sequentially from the antenna 111.

As described above, the structure of the electromagnetic wave source survey device 100 is explained. Next, the principle by which the electromagnetic wave source survey device 100 calculates the direction of current flowing on the EUT 200 will be explained.

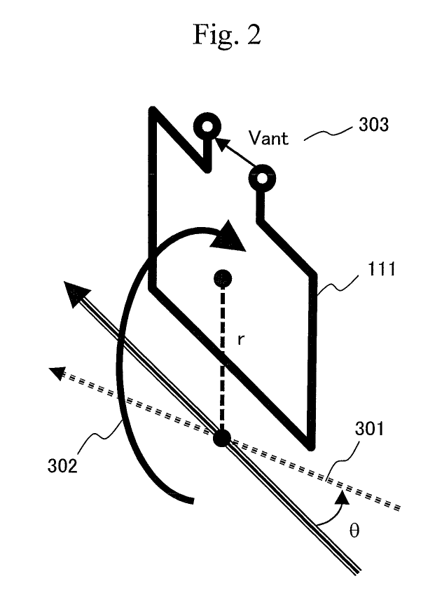

FIG. 2 is a diagram showing the production of induced voltages on the antenna 111 by the current flowing on the EUT 200. The current 301 is a current (i) flowing on the EUT 200 and corresponds to the electromagnetic wave source to be detected by the electromagnetic wave source survey device 100. The antenna 111 is arranged directly above the current 301. The antenna 111 is a magnetic field antenna configured as a loop-antenna, and the area of the loop face is S. The height to (the center part of the loop in) the antenna 111 from the current 301 is r.

When the current 301 flows, the magnetic field 302 (H) is generated. When the magnetic field 302 interlinks the antenna 111, the induced voltages 303 (Vant) is generated on the antenna 111. The angle formed by the loop face of the antenna 111 and the current 301 on the XY plane is θ. The case where the both are in parallel with one another is defined as θ=0°, and the induced voltages 303 in this state is defined as V0.

In this state, the antenna induced voltages 303 (Vant) generated on the antenna 111 can be defined by the below-mentioned formula (formula 1), and V0 can be defined by below-mentioned formula (formula 2). The notation f denotes the frequency of current 301, and μ0 denotes the vacuum permeability.

$$\begin{matrix}{v}_{ant} = {v}_{0} \cdot cos θ & ( formula 1 ) \\ {v}_{0} = \frac{f \cdot {μ}_{0} \cdot S}{r} i & ( formula 2 )\end{matrix}$$

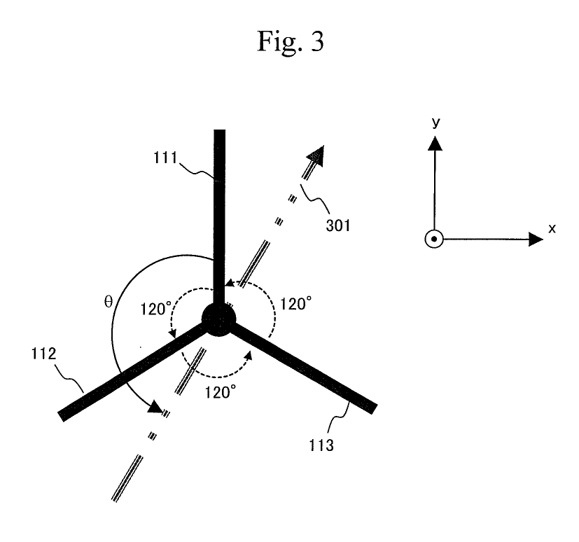

FIG. 3 is a diagram for explaining the technique to estimate the direction of the voltage and the current induced on the antenna module 110. The antenna module 110 is configured so that the antenna 111, the antenna 112 and the antenna 113 are arranged radially at angles of 120 degrees pitch (trisection). Here, with the direction in which the antenna 111 faces on the XY plane being reference, the angle of current 301 is defined as θ. For convenience of the description, hereafter, the current angle θ is an angle with the antenna 111 being reference.

The voltages Vant1-Vant3 induced on the antenna 111—the antenna 113 can be calculated by the below-mentioned formula (formula 3) by using the above-mentioned formulae, (formula 1) and (formula 2).

vₐₙₜ₁=v₀ cos θ

vₐₙₜ₂=v₀ cos(θ−120°)

vₐₙₜ₃=v₀ cos(θ+120°) (formula 3)

The angle θ can be calculated as in the below-mentioned formulae, (formula 4) and (formula 5), with the voltage Vant1 induced on the antenna 1 being the reference. Angle θ1 is used for the angles within the range of 90-180 degrees, and angle θ2 is used for the angles within the range of 0-90 degrees.

$$\begin{matrix}{θ}_{1} = {Tan}^{- 1} \{ - \frac{cos 120 ° + \vert {v}_{ant 2} \vert / \vert {v}_{ant 1} \vert}{sin 120 °} \} & ( formula 4 ) \\ {θ}_{2} = {Tan}^{- 1} \{ \frac{\vert {v}_{ant 3} \vert / \vert {v}_{ant 1} \vert + cos 120 °}{sin 120 °} \} & ( formula 5 )\end{matrix}$$

As above, the principle in which the vectorial angle θ of the current 301 flowing on the EUT 200 is calculated is explained. Next, the procedure in which the electromagnetic wave source survey device 100 calculates the vectorial angle θ of the current 301 by using the above-mentioned principle will be explained.

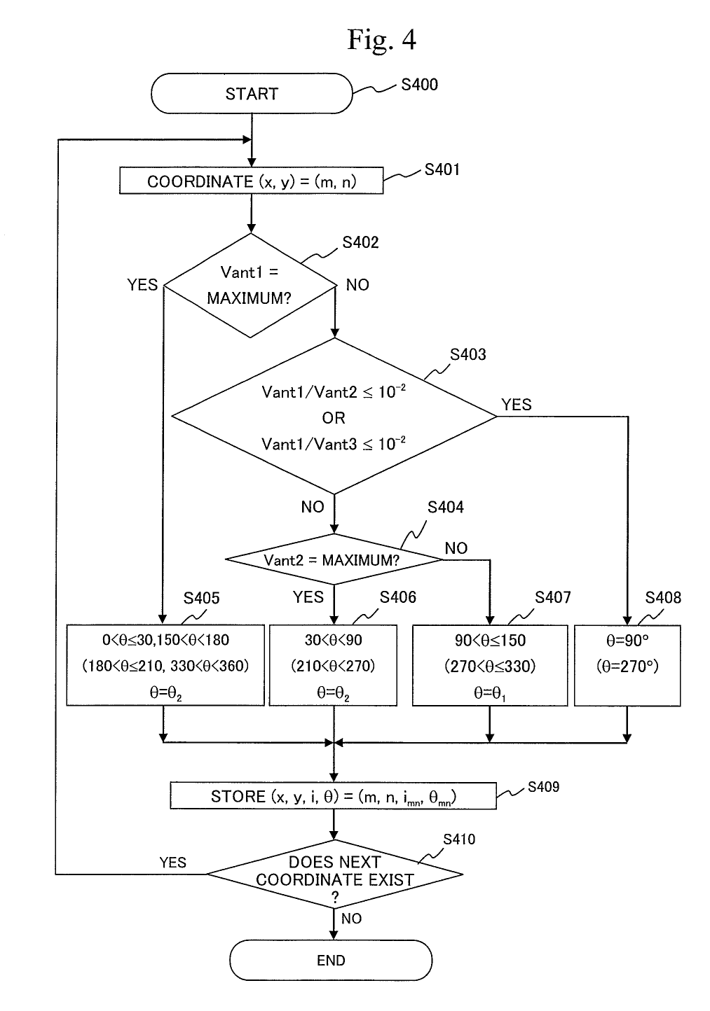

FIG. 4 is the operation flow of the electromagnetic wave source survey device 100. Hereafter, each step in FIG. 4 will be explained.

### (FIG. 4: Step 400)

When a user instructs the electromagnetic wave source survey device 100 to initiate the measurement by using the control computer 170, the present operation flow is initiated.

### (FIG. 4: Step 401)

The control computer 170 sets the coordinate on the XY plane for which the direction of the current 301 is calculated. The XY plane here refers to the plane comprising XY-axis in FIG. 1.

### (FIG. 4: Step 402)

The control computer 170 acquires induced voltages Vant1-Vant3 induced on antennas 111-113, via coaxial switch 140 to spectrum analyzer 150 respectively. In this operation, the control computer 170 switches the coaxial switch 140 as necessary, and assigns the frequency for the spectrum analyzer 150. The control computer 170 determines whether Vant1 is the largest of three induced voltages. In the case where Vant1 is the largest, the process proceeds to step S405, and otherwise the process proceeds to step S403.

### (FIG. 4: Step 403)

The control computer 170 calculates the ratios of Vant1 to Vant2 and Vant3, that is, Vant1/Vant2 and Vant1/Vant3, to determine whether Vant1 is 0 or a value close to 0. The control computer 170 determines that Vant1 is 0 or a value close to 0 in the case where the calculated ratio is a predetermined threshold (for example 10⁻²) or less and the process proceeds to step S408. Otherwise, the process proceeds to step S404.

### (FIG. 4: Step 403: Supplement)

The present step has meaning of determining whether θ=90°. In other words, in the case where Vant2 or Vant3 takes the maximum value, there is a possibility that θ=90°, in which case Vant1=0, division by zero takes place in the above-mentioned formula (formula 4). By the present step, the division by zero is avoided.

### (FIG. 4: Step 404)

The control computer 170 determines whether Vant2 is the largest of three induced voltages. In the case where Vant2 is the largest, the process proceeds to step S406, and otherwise the process proceeds to step S407.

### (FIG. 4: Step 405)

In the case where Vant1 is the largest of the three induced voltages, θ is within the range of 0-30 degrees or 150-180 degrees. The control computer 170 calculates θ by using the above-mentioned formula (formula 5).

### (FIG. 4: Step 406)

In the case where Vant2 is the largest of the three induced voltages, θ is within the range of 30-90 degrees. The control computer 170 calculates θ by using above-mentioned formula (formula 5).

### (FIG. 4: Step 407)

In the case where Vant3 is the largest of the three induced voltages, θ is within the range of 90-150 degrees. The control computer 170 calculates θ by using the above-mentioned formula (formula 4).

### (FIG. 4: Step 408)

The control computer 170 determines θ=90° in the case where it determined Vant1 is 0 or a value close to 0 in step S403.

### (FIG. 4: Step 409)

The control computer 170 stores a coordinate (m, n) on which the above steps have been performed, the value iₘₙ of the current 301, a vectorial angle θₘₙ of the current 301 to a storage device including a memory and a HDD (Hard Disk Drive).

### (FIG. 4: Step 410)

The control computer 170 repeats the same process by going back to step 5401 in the case where it further calculates the direction of the current 301 on the other coordinates on the XY plane. In the case where the direction of the current 301 is not to be calculated any more, the present operation flow is terminated.

As above, the operation flow of the electromagnetic wave source survey device 100 in embodiment 1 has been explained.

As described above, the electromagnetic wave source survey device 100 according to embodiment 1, acquires the absolute values of induced voltages Vant1-Vant3 generated on each antenna to calculate vectorial angle θ of the current 301 by using the formulae, (formula 4) and (formula 5). Since the targets subject to the direct measurement measured by using each antenna are only induced voltages Vant1-Vant3, it is possible to complete measurement in a short time.

In embodiment 1, the antenna module 110 comprises three antennas 111-113 whose arrangement angles are different from one another by 120 degrees incrementing, and the electromagnetic wave source survey device 100 calculates vectorial angle θ of the current 301 by using the arrangement angles. This eliminates angles at which the induced voltages are completely the same for both the X direction and the Y direction. Therefore, the vectorial angle θ can be precisely calculated.

In embodiment 1, since the number of antennas on a same plane is 3, the vectorial angle θ can be calculated more accurately than the case where the number of antennas is 2 or less on a same plane (XY plane).

### Embodiment 2

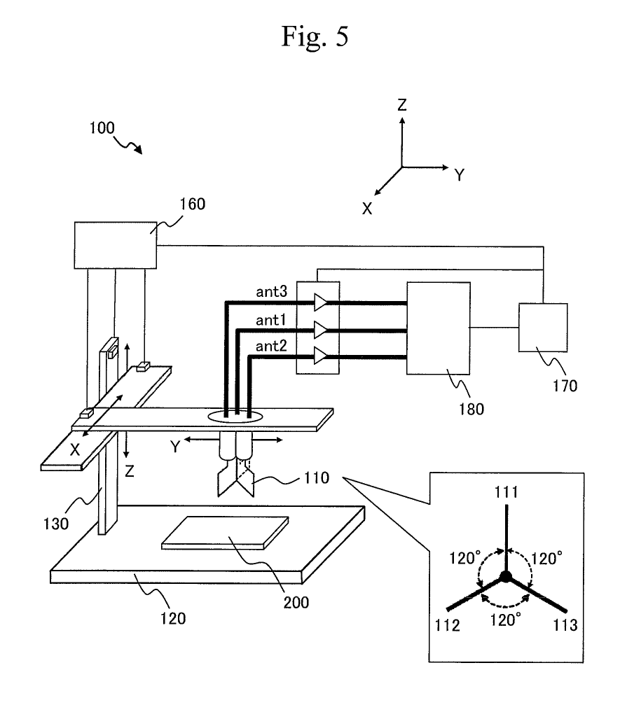

FIG. 5 is a schematic diagram of an electromagnetic wave source survey device 100 according to embodiment 2 of the present invention. The electromagnetic wave source survey device 100 according to embodiment 2 comprises an oscilloscope 180, instead of a coaxial switch 140 and a spectrum analyzer 150 explained in FIG. 1 for embodiment 1.

The oscilloscope 180 has a function to sample a plurality of signal inputs to maintain. Therefore, unlike embodiment 1, there is no need to input signals output by antennas 111-113 while switching the signals one by one, making the coaxial switch 140 unnecessary.

In the case where the output signals are acquired while switching the antennas one by one by using the coaxial switch 140 as described in embodiment 1, it is impossible to yield the output waveform of the same time. On the other hand, with embodiment 2, it is possible to acquire the output waveforms of antennas 111-113 simultaneously by, for example, making the antenna 111 as a trigger. In other words, there is an advantage that the waveforms of all the antennas 111-113 of the same time can be acquired. However, in embodiment 2, there is a need to provide an amplifier for each antenna.

An output signal which the oscilloscope 180 acquires from each antenna is a waveform with respect to a temporal axis. Therefore, the control computer 170 transforms the output signal acquired by the oscilloscope 180 for a spectrum for each frequency by using processes including FFT (Fast Fourier Transform) processes. The control computer 170 acquires an absolute value of the induced voltage for each frequency based on the output of each antenna to calculate vectorial angle θ of the current 301 for each frequency by using the same technique as embodiment 1.

As above, according to embodiment 1, it is possible to yield a signal waveform for each antenna output of the same time simultaneously. Therefore, it is possible to more dynamically perform electromagnetic wave source survey. It is possible to use equipment that, similarly to the oscilloscope 180, has a function to sample and maintain a plurality of signals simultaneously instead of oscilloscope 180.

### Embodiment 3

In embodiment 3 of the present invention, a configuration in which the vectorial angle 0 of the current 301 is calculated by using another method than (formula 4) and (formula 5) explained in embodiment 1.

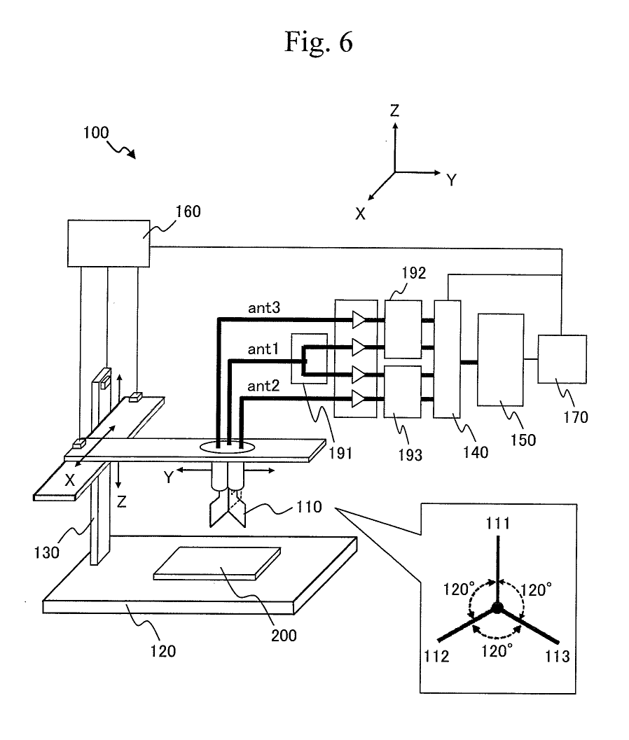

FIG. 6 is a schematic diagram of an electromagnetic wave source survey device 100 according to embodiment 3. The electromagnetic wave source survey device 100 according to embodiment 3 has the following configuration other than the configuration explained in FIG. 1 of embodiment 1.

The coaxial switch 140 in embodiment 3 can input four (or greater number of) signals. Further, a distributer 191, four amplifiers, hybrid baluns 192 and 193 are provided at a stage previous to the coaxial switch 140.

The distributer 191 divides the output of the antenna 111 into two that is to be the reference to calculate the vectorial angle θ. Each divided signal is equal to a signal that is before the division. The four amplifiers amplify the divided output of the antenna 111 and the output of antennas 112-113.

Hybrid baluns 192 and 193 are components said to be 180 degrees hybrid, and output the sums and differences of input two signals. The hybrid balun 192 receives outputs from the antenna 111 and 113, and outputs the sum and difference of these. The hybrid balun 193 receives the outputs of antennas 111 and 112, and outputs the sum and the difference thereof.

The control computer 170 acquires an output of each hybrid balun via the coaxial switch 140 and the spectrum analyzer 150. The control computer 170 can acquire the sum and difference of Vant1 and Vant3 based on the output of the hybrid balun 192. Similarly, based on the output of the hybrid balun 193, it is possible to acquire the sum and difference of Vant1 and Vant2.

Each of Vant1-Vant3 is represented by the above-described formula (formula 3). Since the sums and differences include cos θ and sin θ, it is possible to yield an arithmetic formula to calculate θ by solving simultaneous equations. The control computer 170 calculates θ by substituting the output of each hybrid balun into the arithmetic formula.

As described above, according to embodiment 3, it is possible to yield the same effect as embodiment 1 by using the configuration of the detection equipment and the arithmetic formula that are different from those of embodiment 1. In other words, since the vectorial angle θ is calculated by using only the induced voltages generated on the antennas 111-113, it is possible to finish the measurement in a short time and to precisely calculate the vectorial angle θ based on the arrangement of each of the antennas 111-113.

### Embodiment 4

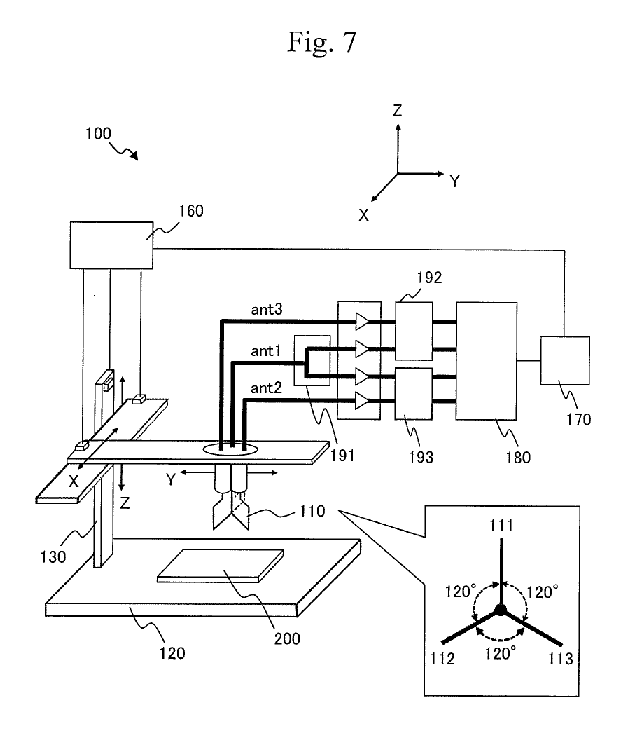

FIG. 7 is a schematic diagram of the electromagnetic wave source survey device 100 according to embodiment 4. The electromagnetic wave source survey device 100 according to embodiment 4 has the configuration as below in addition to the configuration as explained in FIG. 5 of embodiment 2.

The oscilloscope 180 in embodiment 4 can input four (or a greater number of) signals. Further, the distributer 191, the four amplifiers, the hybrid baluns 192 and 193 are provided at a stage previous to the oscilloscope 180.

The functions of the distributer 191, the four amplifiers, the hybrid baluns 192 and 193 are the same as those of embodiment 3. The oscilloscope 180 acquires the time waveform of each input. The control computer 170 acquires the frequency spectrum of the time waveform of each input and calculates θ by using the arithmetic formula that is the same as that explained in embodiment 3 for each frequency.

As above, according to embodiment 4, it is possible to yield the same effect as embodiment 2 by using the configuration of the detection equipment and the arithmetic formula that are different from those of embodiment 2. In other words, since the vectorial angle θ is calculated by using only the induced voltages generated on the antennas 111-113, it is possible to finish the measurement in a short time and to precisely calculate the vectorial angle θ based on the arrangement of each of the antennas 111-113. Further, it is possible to calculate vectorial angle θ by using the output waveforms of the same time of the antennas 111-113.

### Embodiment 5

In embodiments 1 to 4, examples are shown in which the three antennas 111-113 are arranged radially at angles of 120 degrees pitch. However, in order to calculate the vectorial angle θ of the current 301, it is not always necessary that arrangement angles of the antennas are equal as seen from the reference angle. The embodiment 5 of the present invention will explain an example in which the arrangement angles of the antennas are more generalized.

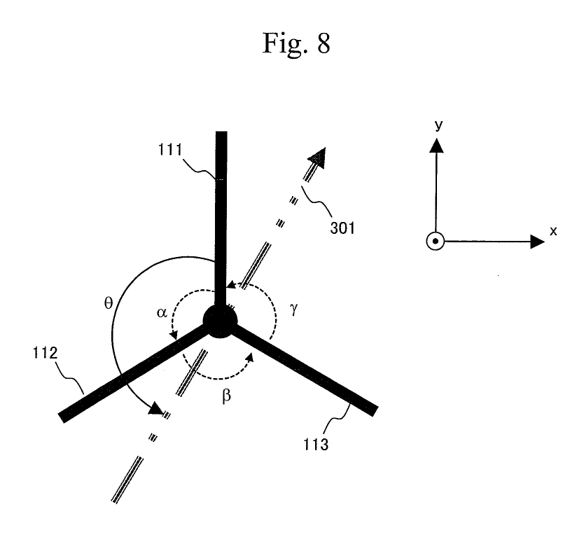

FIG. 8 is a diagram for explaining the method for estimating the direction of the voltage and the current induced on the antenna module 110. Unlike FIG. 3 explained in embodiment 1, the antenna 111, the antenna 112 and the antenna 113 are arranged so that the disposed angles of those are set to be angles α, β, γ with the direction in which the antenna 111 faces being the reference angle.

The voltages Vant1-Vant3 induced on the antennas 111-antenna 113 can be calculated in the manner as in the below-mentioned formula (formula 6), by using the above-mentioned formulae, (formula 1) and (formula 2).

vₐₙₜ₁=v₀ cos θ

vₐₙₜ₂=v₀ cos(θ−α)

vₐₙₜ₃=v₀ cos(θ+γ) (formula 6)

The angle θ can be calculated as in the manner of the below-mentioned formulae, (formula 7) and (formula 8), with the voltage Vant1 induced on the antenna 1 being reference. Angle θ1 is used for the angles within the range of 90 degrees to 180 degrees, and θ2 is used for the angles within the range of 0 degree to 90 degrees.

$$\begin{matrix}{θ}_{1} = {Tan}^{- 1} \{ - \frac{cos α + \vert {v}_{ant 2} \vert / \vert {v}_{ant 1} \vert}{sin α} \} & ( formula 7 ) \\ {θ}_{2} = {Tan}^{- 1} \{ \frac{\vert {v}_{ant 3} \vert / \vert {v}_{ant 1} \vert + cos γ}{sin γ} \} & ( formula 8 )\end{matrix}$$

The control computer 170 can calculate the vectorial angle θ of the current 301 by using the above-mentioned formulae, (formula 7) and (formula 8), and the antenna module 110 in which the three antennas 111-113 are arranged at arbitrary arrangement angles. For example, when α=120° and y=120° are substituted into (formula 7) and (formula 8), they are the same as the formulae, (formula 4) and (formula 5). The overall operation procedure of the electromagnetic wave source survey device 100 may be similar to FIG. 4 explained in embodiment 1.

Further, in FIG. 8, by measuring Vant1-Vant3 at the time when the angle θ of the current 301 is varied at 2 or more points, it becomes possible to calculate pitch angles α, β, γ of the antenna module 110 by substituting into formula (6) to solve the simultaneous equation. This makes it possible to construct the pitch angles of the antennas in the antenna module 110 that are essential to estimate the direction of current.

As above, a method for estimating the direction of the voltage and current induced on the antenna module 110 in embodiment 5 is explained. The method explained in embodiment 5 can be applied to the configurations of the electromagnetic wave source survey device 100 explained in embodiments 2 to 4.

### Embodiment 6

The electromagnetic wave source survey methods described in embodiments 1 to 5 can be applied to an already-existing electromagnetic wave source survey device by introducing the processes executed by the control computer 170. For example, it is conceivable to implement the above-stated processes executed by the control computer 170 as a software program (electromagnetic wave source survey program) and install the electromagnetic wave source survey program to the control computer or the arithmetic device of the already-existing electromagnetic wave source survey device.

More specifically, methods are conceivable in which, the above-mentioned electromagnetic wave source survey program is installed to the control computer, or processes executed by the electromagnetic wave source survey programs are installed in a circuit device, to configure an arithmetic device and control the electromagnetic wave source survey device by the arithmetic device.

However, the electromagnetic wave source survey device in which the above-mentioned electromagnetic wave source survey program is installed needs to be able to detect the induced voltages in 3 directions on the XY plane, in the same way as the antenna module 110 described in embodiments 1 to 5. Any electromagnetic wave source survey devices, as long as it satisfy the condition, can exercise the effect that is the same as the electromagnetic wave source survey method described in embodiments 1 to 5 by introducing the processes executed by the control computer 170, regardless of specific device configurations.

### Embodiment 7

In embodiment 7 of the present invention, examples will be explained in which each of the antennas 111-113 is implemented on a printed wiring board as a manner of implementation of the antenna module 110. The configuration other than the manner of implementation of the antenna module 110 is the same as embodiments 1 to 6.

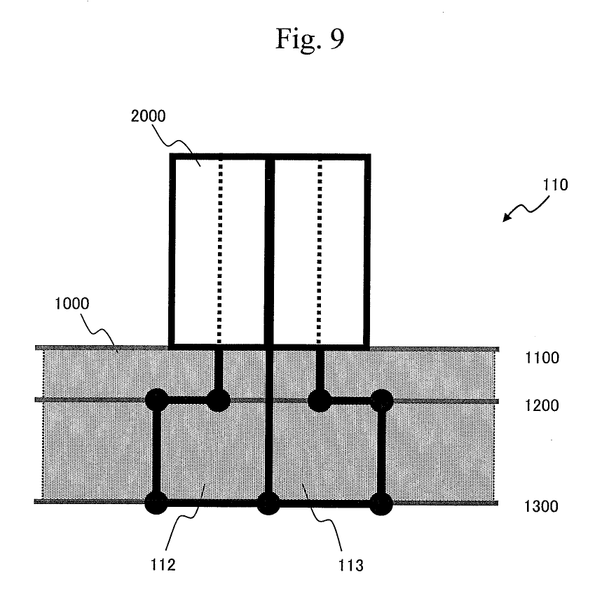

FIG. 9 shows a side cross-sectional view of the antenna module 110. The antenna module 110 in embodiment 7 has a configuration in which each antenna 111-113 is formed inside an antenna module substrate 1000 by metal wiring. Here, an example is shown in which, similarly to embodiment 1, each of the antennas 111-113 is formed as a loop-antenna with the arrangement angles thereof being different from one another with the direction in which the antenna 111 faces being the reference angle.

A coaxial cable 2000 is connected to the surface of the antenna module substrate 1000, and each antenna and the coaxial cable are connected directly or via a connection member such as a connector. On the back face of the antenna module substrate 1000, a common GND via 1310 for grounding each antenna and the coaxial cable 2000 exists.

The antenna module 110 is internally separated into two layers with a part that forms one side of the loop-antenna being the interface. For convenience of the following explanation, a face to which the coaxial cable 2000 is connected is referred to as the face 1100, a face in which one side of the loop-antenna is wired inside is referred to as a face 1200, and a face opposed to the EUT 200 is referred to as the face 1300.

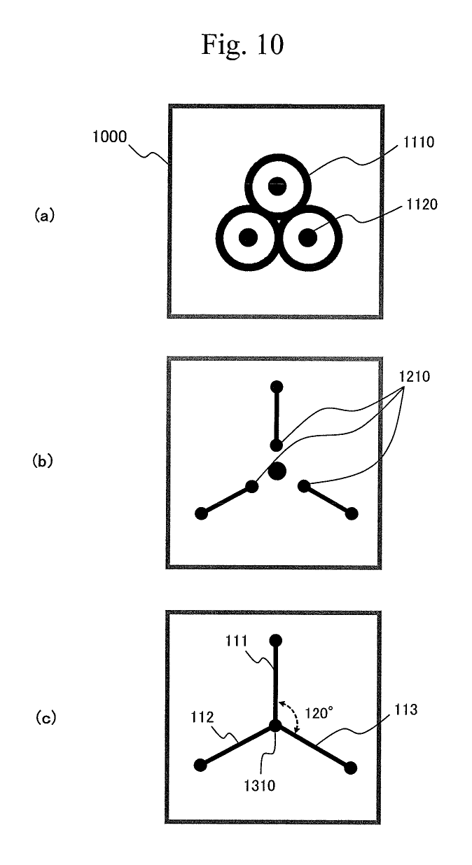

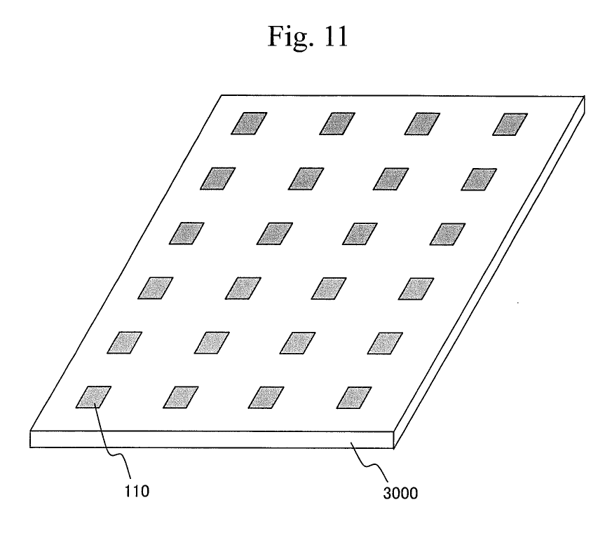

FIG. 10 is a plan view in which the faces 1100, 1200, and 1300 are seen from the side of the coaxial cable 2000. FIG. 10(a), FIG. 10(b) and FIG. 10(c) respectively show the plan views of face 1100, face 1200, and face 1300.

On the face 1100, three signal patterns 1120 that connect each of the antennas 111-113 to the coaxial cable 2000, and a GND pattern 1110 for grounding the coaxial cable 2000 are formed. The GND pattern 1110 is connected to a common GND via 1310 described below.

On the face 1200, a signal via 1210 connected to the signal pattern 1120 is formed.

On the face 1300, a common GND via 1310 is formed. The common GND via 1310 is connected to the external GND of the antenna module 110. Further, each of the antennas 111-113 and GND pattern 1110 are connected to the common GND via 1310. The antennas 111-113 are arranged at arrangement angles explained in any of embodiments 1 to 6.

As described above, according to embodiment 7, since the antenna module 110 is implemented on the printed wiring board, there is a benefit that the antenna module 110 is precisely manufactured with a method used in manufacturing printed wiring board. For example, the arrangement angles of the antenna 111-113 can be strictly controlled.

### Embodiment 8

FIG. 11 is a perspective view of an antenna array substrate 3000 according to embodiment 8 of the present invention. By using the method explained in embodiment 7 in which the antenna module 110 is manufactured on the printed wiring board, a plurality of antenna modules 110 can be arranged on the substrate. This makes it possible to form a planar antenna in which the antenna module 110 is arranged in the array-like shape.

By using the antenna array substrate 3000, it is possible to detect the current flowing on the plane without moving the antenna module 110, or with a small amount of the movement thereof Therefore, there is no need to provide a movement mechanism as the three-axis scanner 130, which results in a benefit to simplify the configuration of the electromagnetic wave source survey device 100.

### Embodiment 9

Although the above embodiments 1 to 8 have explained that the antenna module 110 has three antennas 111-113, the number of antennas may not be always three. However, in order to avoid the situation in which the induced voltages generated in each axial direction is completely the same as one another as in Patent Literature 1, it is desirable that the number of antennas is an odd-number. Further, since it becomes difficult to accurately detect the vectorial angle θ of the current 301 when the number of antennas becomes two or less, it is desirable that the number of antennas is three or greater.

Further, in embodiments 1 to 8 as described above, although it has been explained that each of the antennas 111-113 is a magnetic field antenna formed as a loop-antenna, it is possible to use an electrical field antenna instead of or in parallel with the magnetic field antenna. In other words, it is possible to adopt an arbitrary antenna as long as it is an antenna that can detect electromagnetic wave generated due to the current 301. However, in accordance with the structure in which the antenna detects an electromagnetic wave, the above-stated formula (formula 2) needs to be modified.

In the case where the number of antennas is greater than 3, and where antennas other than the loop-antenna are used, the principle to calculate the vectorial angle θ of the current 301 by using the arrangement angles of each antenna are same.

### REFERENCE SIGNS LIST

100: Electromagnetic wave source survey device, 110: antenna module, 111-113: antenna, 120: stage, 130: three-axis scanner, 140: coaxial switch, 150: spectrum analyzer, 160: motor control unit, 170: control computer, 180: oscilloscope, 191: distributer, 192-193: hybrid balun, 200: EUT, 301: current, 302: magnetic field, 303: induced voltages, 1000: antenna module substrate, 1100, 1200, 1300: face, 1110: GND pattern, 1120: signal pattern, 1210: signal via, 1310: common GND via, 2000: coaxial cable, 3000: antenna array substrate.

1. A method for surveying an electromagnetic wave source generating an electromagnetic wave, comprising:
a step of acquiring a voltage generated by the electromagnetic wave source on three or more odd number of antennas whose respective arrangement angles seen from a reference position on a same plane are different from one another;
a step of assigning, from among the three or more antennas, a reference antenna to be a reference for calculating a direction in which the electromagnetic wave source faces, and a second antenna that is different from the reference antenna;
an absolute value calculation step of calculating an absolute value of the voltage generated on the reference antenna and the absolute value of the voltage generated on the second antenna; and
an angle calculation step of calculating a vectorial angle of the electromagnetic wave source with the reference antenna being a reference by using a difference between the arrangement angles of the reference antenna and the second antenna and the absolute value.

2. The electromagnetic wave source survey method according to claim 1, wherein in the absolute value calculation step,
a frequency spectrum of a time waveform of the voltage generated on the reference antenna and a time waveform of the voltage generated on the second antenna are acquired, and an absolute value of the voltage corresponding to the obtained frequency is calculated.

3. The electromagnetic wave source survey method according to claim 1, wherein in the absolute value calculation step,
an absolute value of an added value of the voltage generated on the reference antenna and the voltage generated on the second antenna and an absolute value of a differential value between the voltage generated on the reference antenna and the voltage generated on the second antenna are acquired; and
in the angle calculation step,
the vectorial angle of the electromagnetic wave source is calculated by using an absolute value of the added value and the absolute value of the differential value.

4. An electromagnetic wave source survey program, wherein the electromagnetic wave source survey program causes a computer to execute the electromagnetic wave source survey method according to claim 1.

5. An electromagnetic wave source survey device comprising:
three or more odd number of antennas whose arrangement angles seen from a reference position on a same plane are different from one another, and
an arithmetic device that executes the electromagnetic wave source survey method according to claim 1.

6. An electromagnetic wave source survey device comprising:
three or more odd number of antennas whose arrangement angles seen from a reference position on a same plane are different from one another;
a measuring equipment that measures a voltage generated at a same time on the three or more of antennas and maintains the value of each of the voltages; and
an arithmetic device that executes an electromagnetic wave source survey method according to claim 2.

7. An electromagnetic wave source survey device comprising:
three or more odd number of antennas whose arrangement angles seen from a reference position on a same plane are different from one another;
a measuring equipment that measures the voltage generated on the reference antenna and the voltage generated on the second antenna and acquires an added value and a differential value of the voltage generated on the reference antenna and the voltage generated on the second antenna; and
an arithmetic device that executes an electromagnetic wave source survey method according to claim 3.

8. The electromagnetic wave source survey device according to claim 5, wherein the antenna is implemented on a printed wiring board.

9. The electromagnetic wave source survey device according to claim 8, further comprising an antenna module array in which a plurality of antenna modules in which the three or more antennas are paired are arranged.
